(19) United States
(12) Patent Application Publication
(10) Pub. No.: US 2006/0039165 A1
(43) Pub. Date: Feb. 23, 2006

(54) Illuminated Apparel and Other Articles

(75) Inventors: Christopher L Harris, Houston, TX (US); Marcus D Brocato, Kemah, TX (US); Beau Carpenter, League City, TX (US)

Correspondence Address: WONG, CABELLO, LUTSCH, RUTHERFORD & BRUCCULERI,;P.C., 20333 SH 249, SUITE 600, HOUSTON, TX, 77070, US

(73) Assignee: GLOTHONG LLC, League City, TX (US)

(21) Appl. No.: 11/161,816

(22) Filed: Aug. 17, 2005

Related U.S. Application Data
(60) Provisional application No. 60/602,098, filed on Aug. 17, 2004.

(51) Int. Cl. F21V 7/04

(52) U.S. Cl. 362/605

(57) ABSTRACT

An illuminated article includes a module incorporated into the article. The module has a compact housing for a rechargeable battery and inverter circuitry. The inverter circuitry includes a power inverter converting direct current power from the battery to alternative current for output power. The module can also include an illuminated panel. In one embodiment, the illuminated article is an item of apparel, such as a bikini bottom or thong. The module of the apparel positions adjacent a wearer's body and forms a structural component for supporting the apparel on the wearer. Electroluminescent (EL) wires are coupled to the output power of the circuitry and are attached to one or more clothing portions of the apparel. The EL wires position against the wearer's body and also form a structural support for supporting the apparel on the wearer.

### CROSS-REFERENCE TO RELATED APPLICATIONS

This application claims the benefit of U.S. Provisional Application Ser. No. 60/602,098, filed Aug. 17, 2004, which is incorporated herein by reference.

### FIELD OF THE DISCLOSURE

The subject matter of the present disclosure generally relates to illuminated apparel and other articles and more particularly relates to apparel or articles having electroluminescent (EL) wire powered by a compact module having an inverter and rechargeable battery, which are incorporated into the apparel or article.

### BACKGROUND OF THE DISCLOSURE

Electroluminescent (EL) wire is known in the art and can glow in many different colors. Details of EL wire are disclosed in U.S. Pat. No. 5,485,355 and China Patent No. 102250. One example of EL wire is LyTec® from ELAM EL Industries Ltd. LyTec® EL wire comes in various grades, such as 1.3-mm, 2.3-mm, 3.2-mm, and 5.0-mm and can be tail or double core EL wire.

In addition to EL wire, ELAM EL Industries Ltd. offers power packs for powering EL wire. One such power pack is the L8F08, which can power an EL wire of up to about 30 to 50-ft. The power pack measures approximately 4×3×1.5-inches. The power pack operates at 600 to 800-Hz and is powered by four M batteries or by a 9-12v DC Jack. The approximate battery life of the power pack is about 23-hrs when set to blinking or about 11.5-hrs. when set to continuous illumination.

Coolight Electroluminescent Wire of Garden, Florida, is another company in the industry that offers various electronics and EL wire. Coolight offers “Belt Inverters,” which are inverters with battery compartments that have a belt clip. For example, the IB8 is a “belt clip” inverter that can operate an EL wire that is up to 18 inches for about 14 hours. Another “belt clip” inverter is the IM-3 inverter, which uses 2 AAA batteries, operates at 3.3 Khz, and can power an EL wire of up to 1 to 3-ft. for about 18-hrs.

Many of the power packs and inverters in the prior art power only one EL wire connected to the inverter and do not power multiple EL wires connected in parallel to the inverter. In addition, many of the power packs and inverters in the prior art are quite large and cumbersome, which makes them unacceptable for use in some implementations or for use with some forms of apparel or other articles. For example, it is not practical to support such typical prior art inverters and power sources on some forms of apparel, such as bathing suits, bikinis, thongs, bras, or the like. Moreover, it is not practical to incorporate such typical prior art inverters and power sources in various articles because of the weight and size of the prior art inverters and power sources.

The subject matter of the present disclosure is directed to overcoming, or at least reducing the effects of, one or more of the problems set forth above.

### SUMMARY OF THE DISCLOSURE

Illuminated articles are disclosed. In one embodiment, the articles include a module having a compact housing incorporated into the article. At least one rechargeable DC battery enclosed in the compact housing provides DC power. Unconventional inverter circuitry is also enclosed in the compact housing together with the at least one rechargeable DC battery. The inverter circuitry is coupled to the DC power of the rechargeable DC battery to produce output AC power. At least one electroluminescent (EL) wire is coupled to the output AC power of the inverter circuitry and is incorporated into the article. In one aspect of the present disclosure, the inverter circuitry is unconventional in that the circuitry can include a power inverter capable of driving an electroluminescent or illuminating panel of a cellular phone and subsequently having its load balancing characteristics adapted so as to drive the electroluminescent wire.

In one embodiment, the illuminated article is an item of apparel worn on the body of a wearer. The illuminated apparel includes one or more clothing portions for positioning adjacent the portions of the wearer's body. In one embodiment, the illuminated apparel can be a bikini bottom or thong, and the clothing portion covers the pubic area of the wearer. In another embodiment, the illuminated apparel can be a bikini top or bra, and the clothing portions cover the breasts of the wearer. In yet another embodiment, the illuminated apparel can be a suit, and the clothing portions can cover the breasts and pubic area of the wearer. The module with its compact housing is incorporated into the apparel as a structural component for supporting the apparel on the wearer. The module positions adjacent the wearer's body. Electroluminescent (EL) wires coupled to the output power of the circuitry in the module are attached to the one or more clothing portions. The EL wires position against the wearer's body and form structural components for supporting the apparel on the body of the wearer.

The foregoing summary is not intended to summarize each potential embodiment or every aspect of the present disclosure.

### BRIEF DESCRIPTION OF THE DRAWINGS

The foregoing summary, preferred embodiments, and other aspects of subject matter of the present disclosure will be best understood with reference to a detailed description of specific embodiments, which follows, when read in conjunction with the accompanying drawings, in which:

FIG. 1 illustrates a front view of first and second embodiments of illuminated articles, namely apparel, according to certain teachings of the present disclosure.

FIG. 2 illustrates a back view of the illuminated apparel of FIG. 1.

FIG. 3 illustrates a module and electroluminescent (EL) wire for the illuminated bikini bottom of FIG. 1.

FIG. 4 illustrates various embodiments of connectors for the disclosed illuminated apparel.

FIGS. 5A-5B illustrate another embodiment of illuminated apparel, namely a bikini suit, according to certain teachings of the present disclosure.

FIG. 6 illustrates yet another embodiment of illuminated apparel, namely a bikini suit, according to certain teachings of the present disclosure.

FIG. 7 illustrates a circuit diagram for a module for the illuminated articles of the present disclosure.

FIGS. 8A-8B illustrate various views of an embodiment of a module for the illuminated articles of the present disclosure.

FIGS. 9A-9C illustrate various views of an embodiment of a module for the illuminated articles of the present disclosure.

FIG. 10 illustrates a charger for recharging batteries of the disclosed module.

FIG. 11 illustrates an embodiment of an illuminated collar according to the present disclosure.

FIG. 12 illustrates yet another embodiment of an illuminated leash according to the present disclosure.

FIG. 13 illustrates embodiments of illuminated belt, shorts, and shirt according to the present disclosure.

FIG. 14 illustrates an embodiment of an illuminated shoe according to the present disclosure.

While the disclosed illuminated articles and module are susceptible to various modifications and alternative forms, specific embodiments thereof have been shown by way of example in the drawings and are herein described in detail. The figures and written description are not intended to limit the scope of the inventive concepts in any manner. Rather, the figures and written description are provided to illustrate the inventive concepts to a person skilled in the art by reference to particular embodiments, as required by 35 U.S.C. § 112.

### DETAILED DESCRIPTION

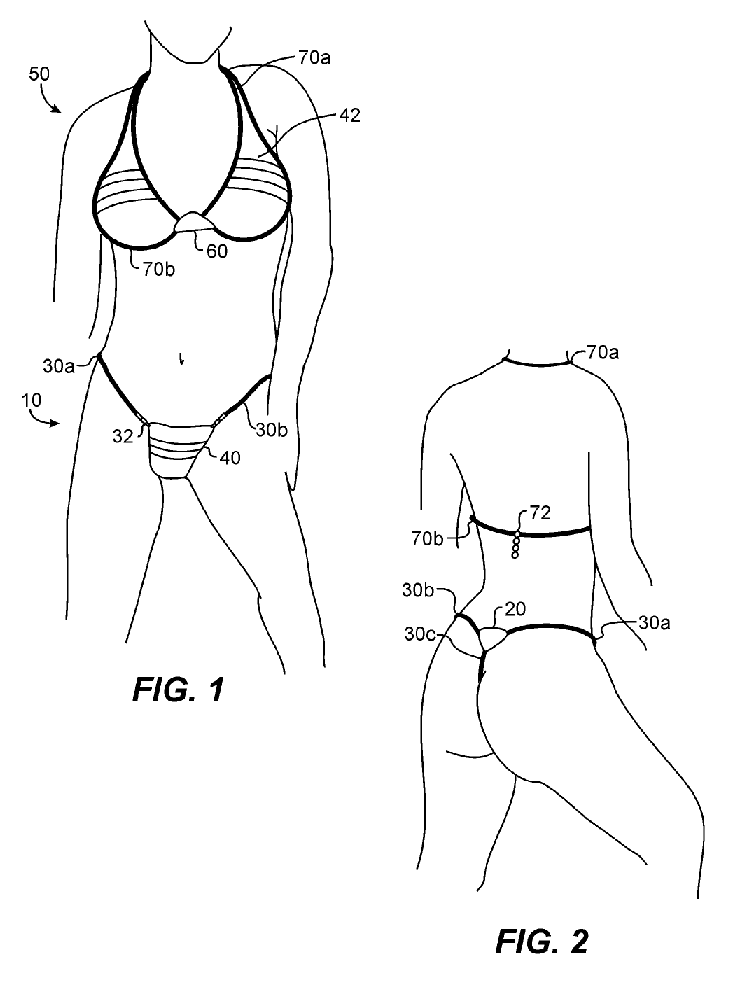

Referring to FIGS. 1 and 2, embodiments of illuminated articles 10 and 50 according to certain teachings of the present disclosure are illustrated. In a first embodiment, the illuminated article 10 is an item of apparel, such as a bikini bottom or thong worn on the body of the wearer. In a second embodiment, the illuminated article 50 is another item of apparel, such as a bikini top or bra.

The bikini bottom 10 includes a compact module 20, a plurality of EL wires 30, and a frontal piece 40. The module 20 has a rechargeable battery and power inverter circuitry, which are not shown but are described in more detail below. As best shown in FIG. 2, the module 20 fits against the back of the wearer. The module 20 is incorporated into the bikini bottom 10 as a structural component to support the bikini bottom 10 on the body of the wearer and can be aesthetically designed for the apparel. The module 20 is compact. In one embodiment, for example, the compact module 20 has a width of about 4.5-cm. (1.8-in.), a height of about 4-cm (1.6-in.), and a thickness of less than 1.5-cm (0.6-in.). In addition, the overall weight of the compact module 20 can be less than 6 to 8 oz.

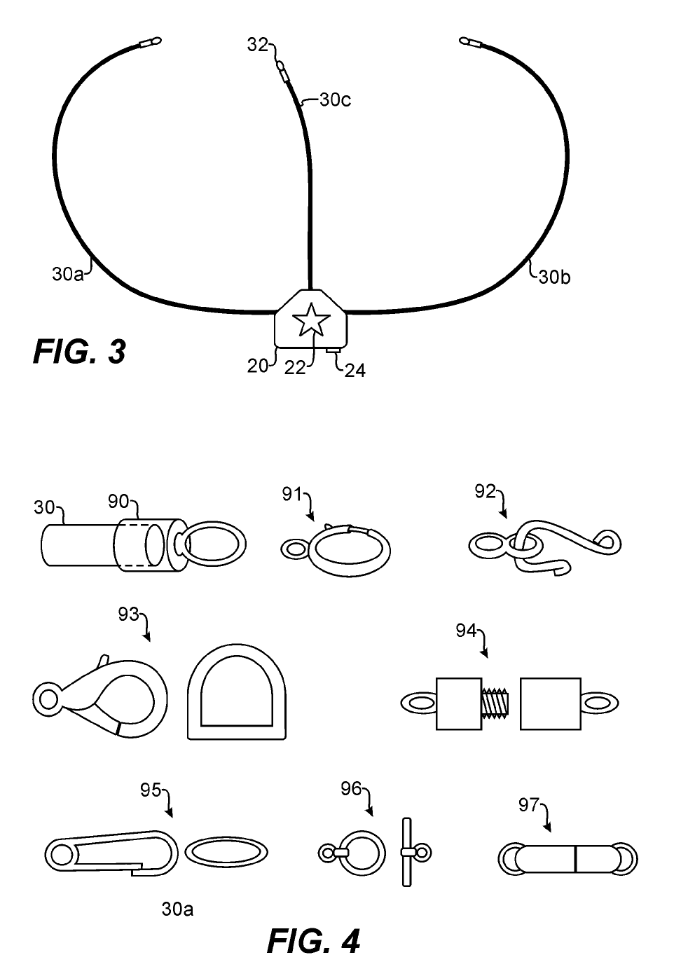

Ends of at least three EL wires 30 are connected to the module 20 and form portions of the bikini bottom 10. (FIG. 3 illustrates an isolated view of the module 20 with connected EL wires 30.) Preferably, the ends of the EL wires 30 connected to the module 20 are not releasable. The EL wires 30 are connected in parallel to the internal electronics of the module 20, as provided in more detail below.

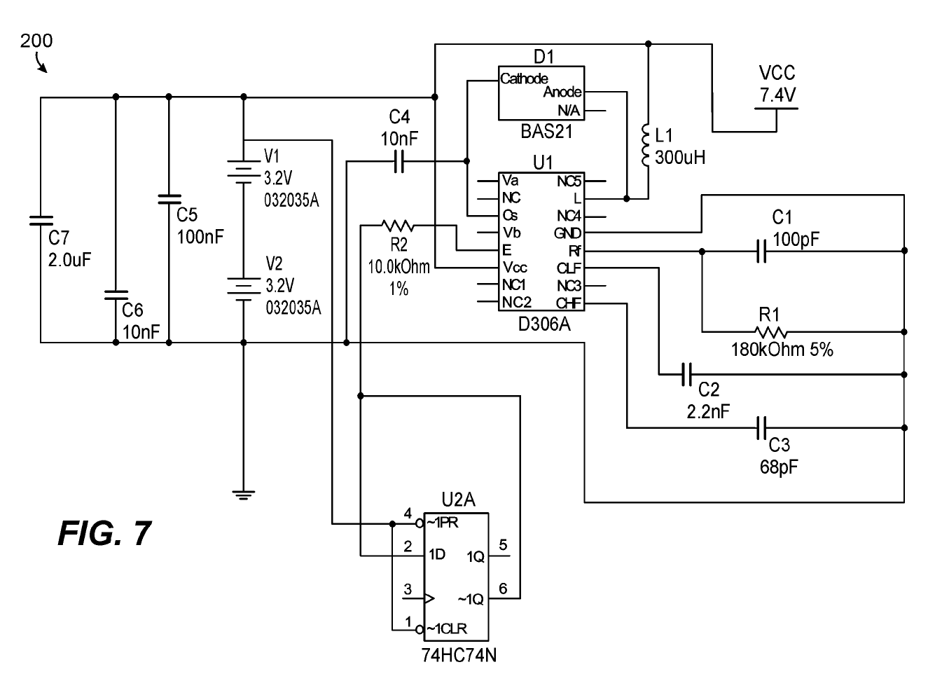

Two EL wires 30a-b fit over the hips of the wearer, while a third EL wire 30c fits between the muscles of the wearer's buttocks. Ends of each of the EL wires 30 are attached to the frontal piece 40, which covers the pubic area of the wearer. Preferably, at least one of the EL wires 30 releasably attaches to the frontal piece 40 to allow the wearer to more easily put on and take off the bikini bottom 10. In one embodiment, the ends of the EL wires 30 have releasable connectors 32 attaching the ends of the EL wires 30 to the frontal piece 40. (FIG. 7 illustrates detailed views of various connectors for use with the EL wires 30.) The connectors 32 attach to three corners of the frontal piece 40, which is generally triangular and can have complimentary portions of the connectors 32 on its three corners. Because the EL wires 30 may readily bend but not stretch, the frontal piece 40 is preferably made of spandex or other stretchable material.

As shown in FIG. 1, the embodiment of the bikini top 50 includes a compact module 60, a plurality of EL wires 70, and cover pieces 80. The module 60 fits against the chest of the wearer and is incorporated into the bikini top 50 as a structural component or portion of the apparel. Ends of four EL wires 70 are connected to the module 60 and form structural portions of the bikini top 50. For example, at least two EL wires 70a extend from the module 60 and loop in opposite directions around the neck of the wearer. These two EL wires 70a then loop on the outside of the breasts, where they are attached to an under EL wire 70b. The under EL wires 70b extend from the module 60, pass under the breasts, and fit around the back of the wearer, as shown in FIG. 2. A connector 72 at the back of the wearer connects the ends of the under EL wires 70b. The connector 72 can be a hook and looped chain or can be another conventional fastener for a bra or bikini top. In an alternative embodiment of the bikini top 50, the module 60 can position at the back of the wearer, and the connector 72 can connect at the chest of the wearer. Because the EL wires 70 are not stretchable, the connector 72 is preferably adjustable.

The cover pieces 80 of the bikini top 50 are generally triangular and cover the breasts of the wearer. The cover pieces 80 can be made of any various materials and can be attached to the EL wire 70 using techniques known in the art. For example, the cover pieces 80 can be sown to the EL wire 70 preferably in a manner that still allows most of the EL wires 70 to be visible. In another example, the cover pieces 80 can have a plurality of loops or hooks attached to the pieces 80 and through which the EL wires 70 pass to connect the pieces 80 to the EL wire 70.

As noted above, FIG. 3 illustrates a detailed view of the module 20 and three EL wires 30 for the embodiment of the bikini bottom 10. The EL wires 30 have connectors 32 for connecting to the cover portion (not shown) of the bikini bottom. As shown in FIG. 3, the module 20 can have an illuminated panel 22, which is described in more detail below and which can illuminate an emblem, logo, insignia, etc. In addition, the module 20 can have a socket 24 for recharging the internal power source of the module 20, which is also described in more detail below.

Referring to FIG. 4, embodiments of various connectors are illustrated. The connectors are used to connect the EL wires to cover or fabric portions of the illuminated apparel disclosed above. In one embodiment, a loops 90 can be attached to the distal end of EL wire 30 by epoxy, crimping, or other technique. The distal ends of the EL wire 30 should be appropriately terminated by techniques known in the art for EL wires. Additional types of connectors can include, but are not limited to, spring rings 91, hook and eye clasps 92, clasp and loop systems 93, barrel clasps 94, lanyard hooks and loops 95, toggle clasps 96, and magnetic clasps 97. For example, a corner of the cover portion 40 in FIG. 2A may have a clasp sewn to the material of the cover portion 40. The clasp may then connect to the loop 90 attached to the distal end of EL wire 30.

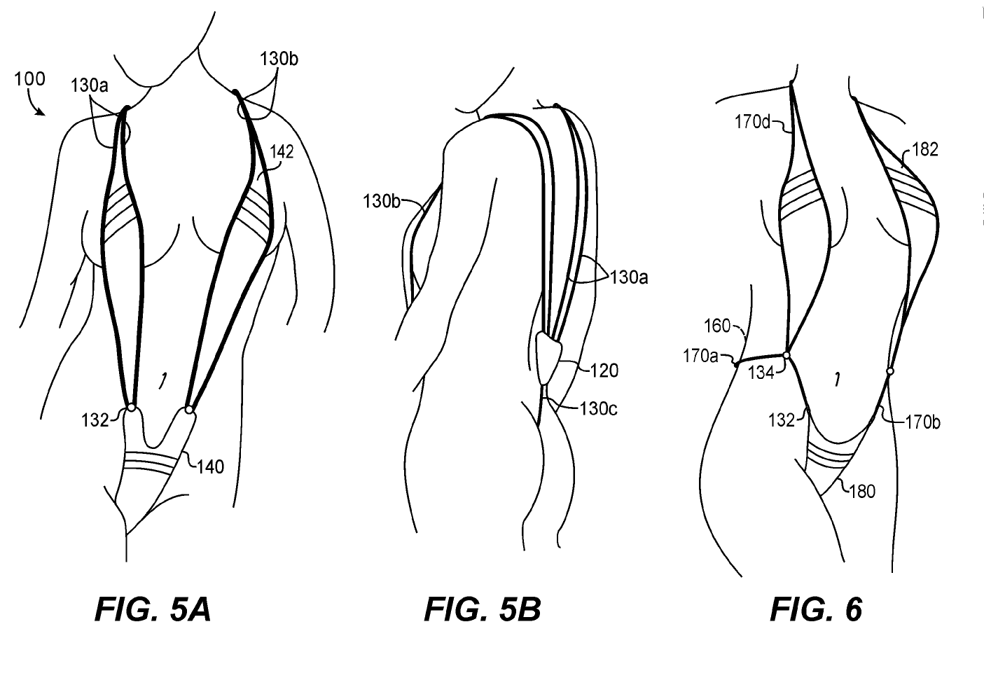

Referring to FIGS. 5A-5B, another embodiment of an illuminated article 100 is illustrated. The illuminated article 100 is also an item of apparel, such as bikini suit. The bikini suit 100 includes a compact module 120, a plurality of EL wires 130, and a plurality of cover pieces 140, 142, and 144. The module 120, which has the inverter and rechargeable battery as before, fits against the back of the wearer and is incorporated into the bikini suit 100 as a structural component. Ends of at least five EL wires 130 are connected to the module 120 and form structural portions of the bikini suit 100. For example, at least four EL wires in two pairs 130a and 130b fit over the shoulders of the wearer, while at least one EL wire 130c fits between the muscles of the wearer's buttocks. Ends of the EL wires 130 connect to at three corners of the frontal piece 140 of the bikini suit 100. One or more of the connectors 132 on the ends of the EL wires 130 can be releasable, although this may not be strictly necessary as the wearer can put on and take of the suit 100 without releasable connectors. The four EL wires 130a and 130b fitting over the shoulders of the wearer can have cover pieces 142 attached that cover the breasts of the wearer.

Referring to FIG. 6, yet another embodiment of an illuminated article 150 is illustrated. The illuminated article 150 is again an item of apparel, such as bikini suit 150. The bikini suit 150 includes a power inverter module 160 (which is not visible in FIG. 6), a plurality of EL wires 170, and a plurality of cover pieces 180, 182, and 184. The module 160 fits against the back of the wearer in much the same fashion as the module (20) of the bikini bottom (10) shown in FIG. 2. Ends of at least three EL wires 170 are connected to the module 160 and form structural portions of the bikini suit 150. One EL wire (not shown in FIG. 6) connects from the module 160, fits between the legs of the wearer, and connects to the frontal piece 180 in much the same manner as the third EL wire (30c) of the bikini bottom (10) shown in FIG. 2.

In one embodiment, at least two of the EL wires 170a-b connect to the module 160 at the back of the wearer and fit over the wearer's hips. Midway over the hips, upward extending, looped portions 170d of the EL wires 170a-b are diverted and extend past the breasts to the neck of the wearer. A connector (not shown) can connect the portions 170d of EL wires 170a-b at the back of the wearer's neck. In this embodiment, each looped portion 170d of EL wires 170a-b loops back from the neck connector (not shown) to the hip of the wearer. Cover pieces 182 and 184 are attached to these looped portions 170d to cover the breasts of the wearer. At the hips of the wearer, the EL wires 170a-b are connected to the other portion of the same wires 170a-b with a gathering 134, and the ends of the EL wires 170a-b connect to the frontal piece 180 with connectors 132.

In another embodiment, at least two EL wires 170a-b connected to the module 160 at the back of the wearer fit over the hips. Midway over the hips, portions 170d of the EL wires 170a-b are diverted and extend past the breasts to the neck of the wearer. At the neck, the portions 170d of the EL wires 170a-b can loop past one another and pass to the other breast of the wearer. Cover pieces 182 and 184 are attached to each of these wire portions 170d to cover the breasts of the wearer. At the hips of the wearer, the EL wires 170a-b are connected to the other portion of the other EL wires 170a-b with a gathering 134, and the ends of the EL wires 170a-b connect to the frontal piece 180 with connectors 132.

Although the foregoing embodiments of apparel in FIGS. 1, 2, 5A-5B, and 6 show single EL wires used for each structural portion of the apparel, it will be appreciated that more than a single EL wire can be used for the various structural portions of the apparel. For example, in the embodiment of the bikini bottom 10 in FIGS. 1 and 2, instead of a single EL wire 30a fitting over one of the hips of the wearer, two or more EL wires similarly connected to the module 20 can run adjacent one another over the one hip of the wearer and act as a structural portion. In this way, the intensity of the illuminated apparel can be increased and the overall structural support and esthetic enhanced. In the interest of clarity, it is therefore understood that the foregoing embodiments of illuminated apparel have been depicted in a basic form, which can be aesthetically redesigned or altered. Furthermore, the forgoing embodiments of illuminated apparel are meant to be illustrative and are not intended to limit the disclosed module (having the power inverter and rechargeable batter) from being used with other article or forms of apparel.

Referring to FIG. 7, preferred driver circuitry 200 of a module for the disclosed articles is schematically illustrated. The driver circuitry 200 is a high voltage inverter designed for flexible use with capacitive loads, which in the present embodiment includes electroluminescent wire and/or a panel. The circuitry 200 uses two rechargeable lithium ion batteries (V1 & V2) as a power source for logic control and for generating an AC high voltage output. In the present embodiment, the control logic uses a dual flip flop (U2) for accomplishing “on and off” latching. The dual flip-flop (U2) provides a logic signal, “on or off,” for the enable signal of the high voltage circuit.

The high voltage of the driver circuitry 200 is generated using an oscillator and a switching bridge, which are contained in a single integrated circuit or chip (U1). The switched output of the chip (U1) pumps the inductor (L1) using capacitor (C4) through switching diode (D1). The flyback from inductor (L1) provides the high voltage source to the load (e.g., EL wires and/or panel). Various capacitors (C1-C3 and C5-C7) and various resistors (R1-R3) are used to shunt noise and set the parameters of the high voltage chip (U1).

The circuitry 200 is designed with all surface mount components for mounting on a printed circuit board (not shown). A multi-layer board design is preferably used, which incorporates noise suppression methodology and shielding to prevent false triggering and logic noise. The circuitry 200 requires approximately 140 mA to operate with a nominal load of EL wire.

Details for various components for one implementation of the circuitry 200 are given in the chart below:

Chart: Detail of Components for Preferred Driver Circuitry

| Component | Description | Function | Manufacture | Part Number |
|---|---|---|---|---|
| PCB1 | Surface | Substrate | Advanced | |
| | mount PC | | Circuits | |
| | board | | | |
| V1 | Lithium ion | Power | IBT Power | 032035A |
| | 3.7 V | source | | |
| | battery | | | |
| | pack | | | |
| | (150 mAh) | | | |
| V2 | Lithium ion | Power | IBT Power | 032035A |
| | 3.7 V | source | | |
| | battery | | | |
| | pack | | | |
| | (150 mAh) | | | |
| U1 | Power | EL supply | Durel | D340B |
| | inverter | | | |
| C1 | 100 pF | CRF | Murata | GRM1885C2A101JA01D |
| | Capacitor | | Electronics | |
| | | | North America | |
| C2 | 2.2 nF | CLF | TDK | C1608X7R2A222K |
| | Capacitor | | Corporation | |
| C3 | 68 pF | CHF | Murata | GRM1885C2A680JA01D |
| | Capacitor | | Electronics | |
| | | | North America | |
| C4 | 10 nF | Cs | Murata | GRM188R71C103KA01D |
| | Capacitor | | Electronics | |
| | | | North America | |
| C5 | 100 nF | Support | Murata | GRM32NF52A104ZA01L |
| | Capacitor | component | Electronics | |
| | | | North America | |
| C6 | 10 nF | Support | Kemet | C0603C103K5RACTU |
| | Capacitor | component | | |
| C7 | 2.2 microF | S | Murata | GRM188F51A225ZE01D |
| | Capacitor | | Electronics | |
| | | | North America | |
| L1 | 330 | L | Murata | LQH32CN331K23L |
| | microH | | Electronics | |
| | Inductor | | North America | |
| R1 | 180 kOhm | RF | Yageo America | 9C0603A1803JLHFT |
| | Resistor | | | |
| R2 | 10 kOhm | E | Yageo America | 9C06031A1002JLHFT |
| | Resistor | | | |
| U2 | Flip Flop | Switch | Texas | SN74HCT74DR |
| | | Latch | Instruments | |
| SW1 | Membrane | Switch | | |
| | touch pad | | | |
| J1 | Power | Recharging | Kobiconn | 163-4312 |
| | connector | input jack | | |
| | 0.7 mm | | | |
| D1 | 600 mA | Charge cap | Fairchild | BAS21 |
| | 250 V | pumping | Semiconductor | |
| | switching | path | | |
| | diode | | | |
| R3 | 2.2 Mohm | Support | Yageo America | 9C06031A2204JLHFT |
| | Resistor | component | | |
| D2 | 3.6 V Zener | Support | Diode Inc. | MMBZ5227B-7 |
| | Diode | component | | |
| J1 | 0.7 mm | Charge | CUI Inc. | CA-2196 |
| | power cord | cord | | |
| | w/ molded | | | |
| | plug | | | |

The power inverter chip (U1) in the present embodiment is an electroluminescent lamp driver from Durel having part number D340B. The chip (U1) is originally designed to illuminate a panel or electroluminescent lamp of a cellular phone. The load characteristics of an electroluminescent lamp for a cellular phone and the load characteristics of EL wire are substantially different. Therefore, it was not expected that the chip could be used to drive and illuminate EL wire. Despite this unexpected capability of the chip (U1), a four variable analysis of the chip (U1) was used to set the parameters of the chip to enable it to drive and illuminate EL wire.

The circuitry 200 of the module of the present disclosure has a number of advantages over conventional drivers known and used in the art to drive EL wire. The prior art drivers have conventional inverters and AA battery power supplies. Some examples of the conventional inverters have been discussed in the Background of the present disclosure. In contrast to the prior art drivers, the circuitry 200 of the present disclosure uses an unconventional inverter, which is designed to drive a panel of a cellular phone. Furthermore, the circuitry 200 uses rechargeable lithium ion batteries for its power source, and the circuitry 200 provides for a driver module that is substantially smaller, lighter, and more compact than conventional drivers known in the art for driving EL wire.

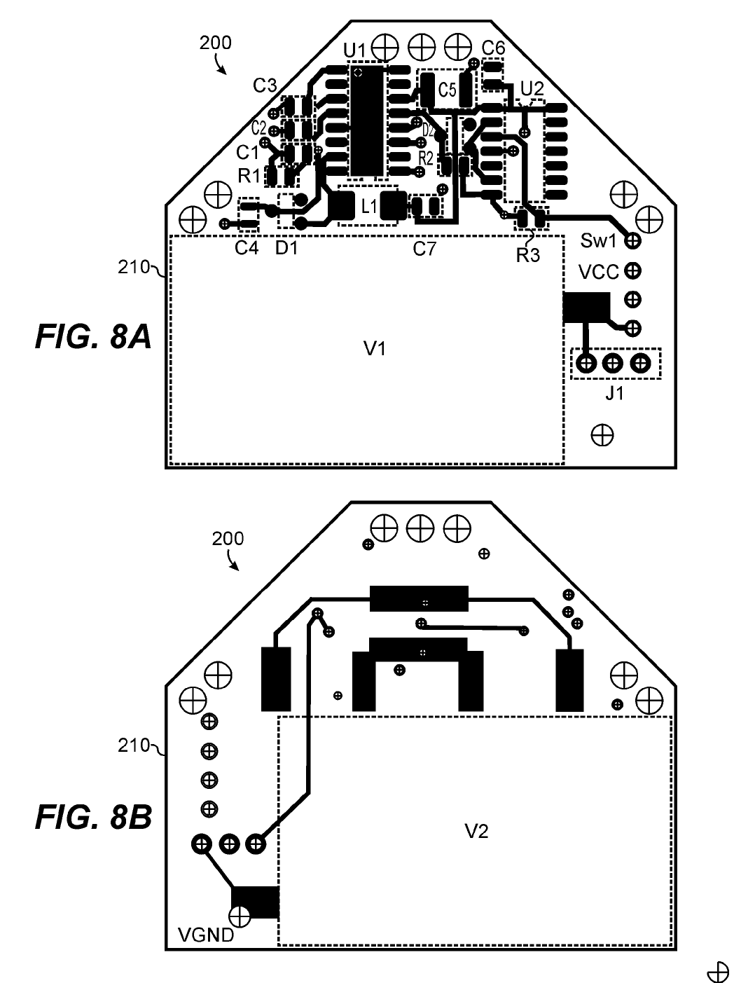

Referring to FIGS. 8A-8B, an embodiment of a layout of the circuitry 200 for the disclosed module is illustrated on a PC board 210. A top side 212 of the PC board 210 is shown in FIG. 7A, and a bottom side 214 of the PCB board 210 is shown in FIG. 7B. The layout of the circuitry shows the preferred locations of the various electronic components (V1-2, U1-2, C1-7, L1, R1-2, SW1, J1, and D1-2) of the circuitry 200 of FIG. 6 to provide a small, light, and compact driver module.

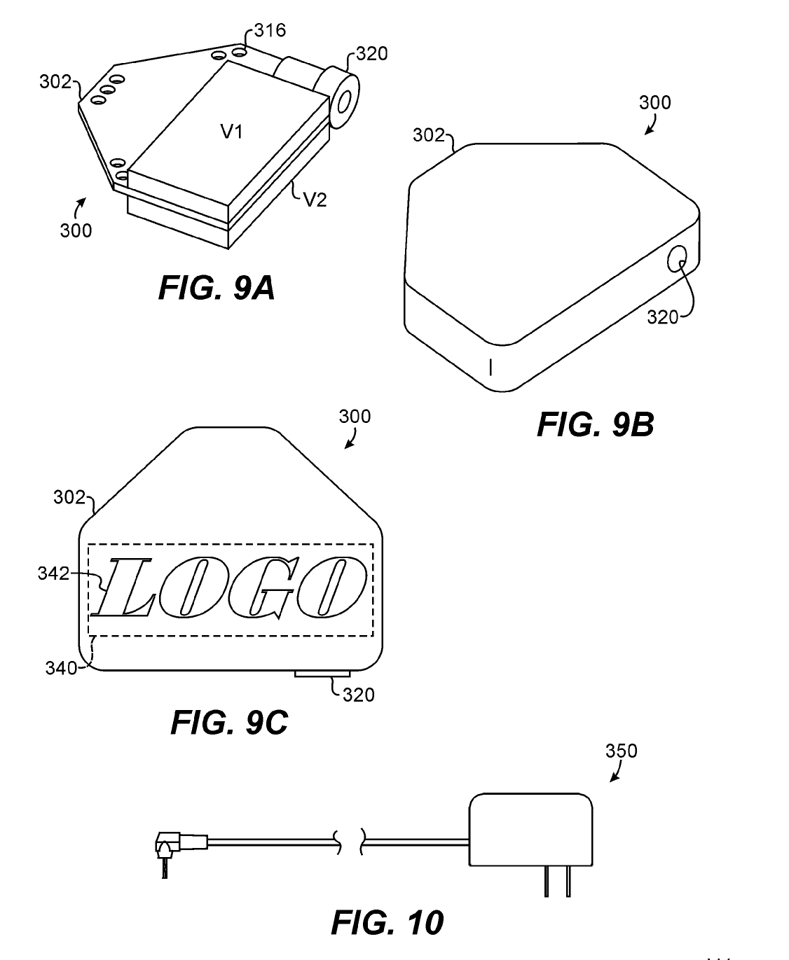

Referring to FIGS. 9A through 9C, an embodiment of a module 300 of the present disclosure is illustrated various views. In FIG. 9A, the module 300 is shown without most of the electronic components on PC board 310. Preferably, the batteries V1 and V2 are mounted one either side of the PC board 310 to maintain compactness of the module 300. A socket 320 for a charger is mounted on the PCB 302 and is used for recharging the batteries V1 and V2. Preferably, the batteries V1 and V2 are Lithium Ion battery packs (3.7-V & 150-mAh), such as those manufactured by IBT Power and having part number 032035A. Various holes 316 are formed in the PC board 310 for attaching the EL wires (not shown) to the PC board 310.

In FIG. 9B, an outside view of the module 300 is shown. Preferably, a housing 302 covers the PC board, batteries, and other electronics of the module 300. In one embodiment, the housing 302 include an enclosure that is preformed from plastic and adapted to cover the internal components so that the module 300 is substantially waterproof. In an alternative to or in conjunction with the enclosure, the housing 302 can include encapsulation. The encapsulation of the module 300 involves dipping the PC board (310; FIG. 9A) having the electronics and batteries into a suitable encapsulation material, such as a casting resin, to fully encapsulate the module 300. In either case, the housing 300 allows for access to an end of the charger socket 320.

In FIG. 9C, the module 300 is shown with a luminescent screen or panel 340, such as used to backlight cell phones or the like. The panel 340 is connected to the internal electronics (not shown) of the module 300. Portions of the panel 340 are covered by the housing 302, and other portions 342 of the panel 340 are visible through transparent or cutout portions of the housing 302. In this way, the module 300 can display a luminescent logo or other design when it illuminates the panel 340.

Referring to FIG. 10, a charger 350 for the rechargeable batteries of the module is illustrated. As noted above, the module preferably has two 3.7-V lithium ion batteries. Preferably, the charger 350 uses conventional AC power input and converts it to 7.4V DC power at 500-mA. In addition, the charger 350 is preferably controlled by a conventional circuit for charging lithium-ion batteries, such as known in the art.

As discussed previously, the module of the present disclosure can be incorporated into items of apparel, such bikini bottoms, tops, and suits. In addition to apparel, the advantages of the disclosed module, such as the facts that the module is compact, rechargeable, and waterproof, etc., make the disclosed module suitable for incorporation into a number of other articles.

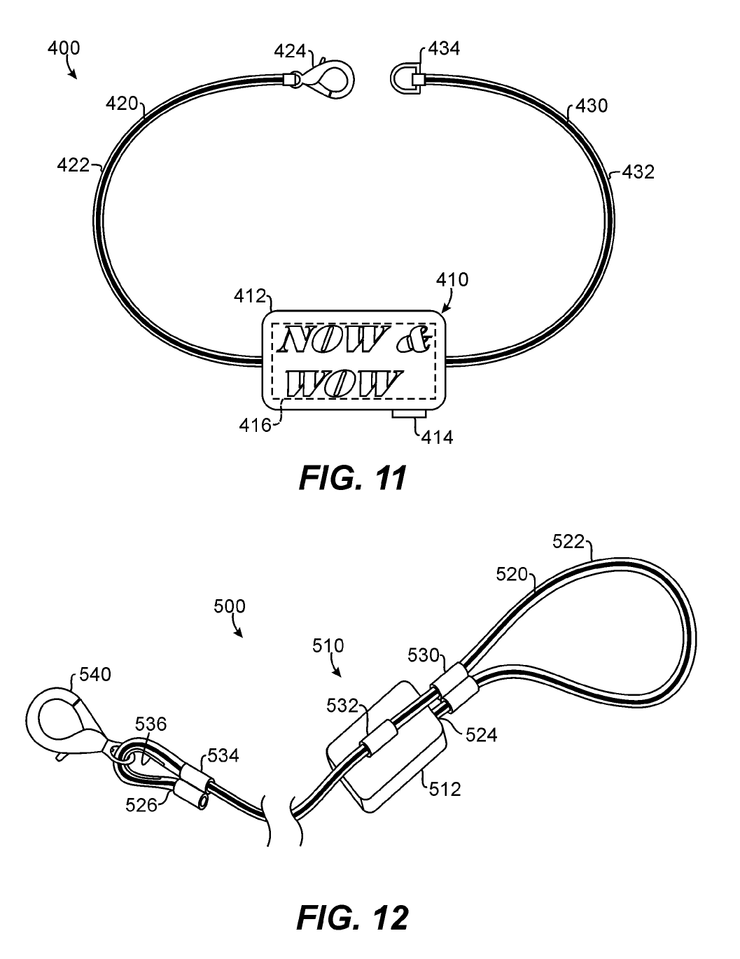

In FIG. 11, for example, an embodiment of an illuminated article 400, namely a collar, includes a module 410 according to the present disclosure. Two EL wires 420 and 430 are connected to the internal electronics of the module 400. The EL wires 420 and 430 have fee ends that have connectors 424 and 434 for connecting the ends together. Again, the module 410 has a housing 412 formed from an enclosure and/or encapsulation, and the module 410 has a recharging socket 414. The module 410 can also drive a panel 416 on the module 410 to illuminate a logo or the like. Preferably, the EL wires 420 and 430 are enclosed in transparent tubing or sheathing 422 and 432 to provide added strength and width. Ends of the sheathing 422 and 432 are preferably mechanically attached to the module 410 using techniques known in the art.

In FIG. 12, an embodiment of another illuminated article 500, namely a leash, also includes a module 510 according to the present disclosure. One end 524 of an EL wire 520 is connected to the internal electronics of the module 510. The EL wire 520 forms a loop for a handle at one end of the leash 500. A mechanical coupling or crimp fitting 530 is used to form this loop for the handle. The module 510 has a housing 512 formed from an enclosure and/or encapsulation. Another coupling 532 is attached to the housing 512 for holding the module 510 to the EL wire 520.

Another end 526 of the EL wire 520 forms a smaller loop and has another mechanical coupling or crimp fitting 534. Metal plating 536 is fixed in the smaller loop at the end 526 of the EL wire 520 to provide added strength for a swivel clasp 540 attached to this smaller loop. Again, the EL wire 520 is preferably enclosed in transparent tubing or sheathing 522 to provide added strength and width. The overall length of the EL wire 520 can be about 5-ft. The tensile of the EL wire is about 80-pounds, while the overall structural tensile strength of the leash 500 can be about 90-pounds.

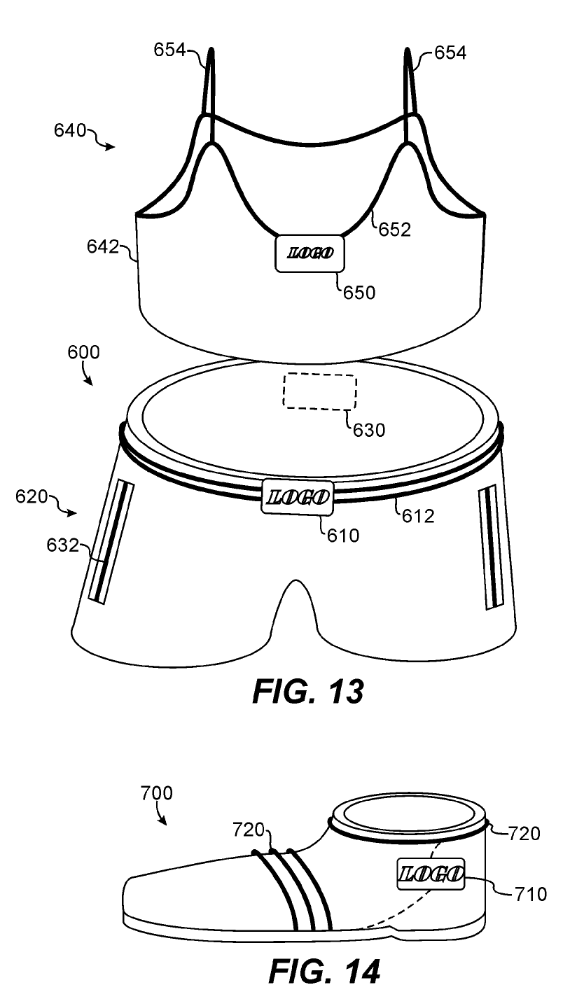

In FIG. 13, embodiments of an illuminated belt 600, shorts 620, and top 640 are illustrated. The illuminated belt 600 has a module 610 as disclosed herein and one or more EL wires 612, which can couple to the module 610 and/or to one another using techniques known in the art. The illuminated shorts 620 also include a module 630, which is preferably incorporated into (e.g., attached to or sown into) the fabric of the shorts 620. One or more EL wires 632 are connected to the module 630 and can be attached to or sewn into the fabric of the shorts 620. Portions of the EL wires 632 are exposed or visible on the shorts 650, while other portions can be hidden within the fabric.

In FIG. 13, the illuminated shirt or top 640 also has a module 650 as disclosed herein and one or more EL wires 652 coupled to the module 610. The module 650 and EL wires 652 are incorporated into the top 640. In particular, the module 650 is attached to the EL wires 652, and both form a structural component of the top 640 in that the module 650 and EL wires 652 are attached to the fabric 642 of the top 640 and support the fabric 642 on the body of the wearer. Furthermore, portions 654 of the EL wire 652 form straps of the top 640 and support the top 640 on the body of the wearer.

In FIG. 14, an embodiment of an illuminated shoe 700 is illustrated. The shoe 700 has a module 710 as disclosed herein and one or more EL wires 720. The module 710 is attached to, sewn into, or embedded into the material of the shoe. In addition, portions of the EL wires 720 can be attached to, sewn into, or embedded in the material of the shoe 700, while other portions of the EL wires 720 can be exposed or visible from outside the shoe 700.

In addition to the embodiments of articles disclosed herein, the module of the present disclosure can be incorporated into a number of other articles, including, but not limited to, athletic gear, sandal, backpack, bicycle, uniform, pom-pom, duffle bag, hat, helmet, lanyard, life saving equipment, lingerie, swimming trunks, pants, clothing, motorcycle, mountain gear, safety vest, raincoat, jogging gear, scuba gear, and an umbrella.

The foregoing description of preferred and other embodiments is not intended to limit or restrict the scope or applicability of the inventive concepts conceived of by the Applicants. In exchange for disclosing the inventive concepts contained herein, the Applicants desire all patent rights afforded by the appended claims. Therefore, it is intended that the appended claims include all modifications and alterations to the full extent that they come within the scope of the following claims or the equivalents thereof.

What is claimed is:

1. A device, comprising:
a power source for the device providing direct current input power;
inverter circuitry for the device coupled to the direct current input power of the power source and producing alternating current output power, the inverter circuitry including a power inverter capable of driving an electroluminescent panel of a cellular phone and having its load balancing characteristics adapted to drive electroluminescent wire; and
at least one first electroluminescent wire for the device coupled to the alternating current output power of the inverter circuitry such that the alternating current output power illuminates the at least one first electroluminescent wire.

2. The device of claim 1, comprising a housing enclosing the power source and the inverter circuitry.

3. The device of claim 2, wherein the power source comprises at least one rechargeable battery enclosed in the housing.

4. The device of claim 2, wherein the housing comprises an encapsulation enclosing the inverter circuitry and the power source together in the device.

5. The device of claim 4, wherein the encapsulation is waterproof.

6. The device of claim 1, further comprising an electroluminescent panel for the device coupled to the alternating current output power of the inverter circuitry.

7. The device of claim 1, further comprising a second electroluminescent wire for the device coupled to the alternating current output power of the inverter circuitry in parallel to the at least one first electroluminescent wire.

8. An illuminated article, comprising:
a module incorporated into the illuminated article and at least including:
a housing,
a rechargeable power source enclosed in the housing and providing direct current input power,
inverter circuitry enclosed in the housing, the inverter circuitry coupled to the direct current input power and producing alternating current output power; and
at least one first electroluminescent wire incorporated into the illuminated article and coupled to the alternating current output power of the inverter circuitry.

9. The illuminated article of claim 8, wherein the article is selected from the group consisting of apparel, a bikini bottom, a thong, a bikini top, a bra, a bikini suit, a collar, a leash, a belt, shorts, a shoe, a sandal, athletic gear, a backpack, a bicycles, a uniform, a pom-pom, a duffle bag, a hat, a helmet, a lanyard, life saving equipment, lingerie, swimming trunks, clothing, a motorcycle, mountain gear, a safety vest, a raincoat, jogging gear, scuba gear, and an umbrella.

10. The illuminated article of claim 8, wherein the module further comprises an electroluminescent panel enclosed in the housing and at least partially exposed outside the housing, the electroluminescent panel coupled to the alternating current output power of the inverter circuitry.

11. The illuminated article of claim 8, wherein the rechargeable power source comprises at least one rechargeable battery enclosed in the housing.

12. The illuminated article of claim 8, wherein the housing comprises an encapsulation enclosing the inverter circuitry and the rechargeable power source together in the module.

13. The illuminated article of claim 12, wherein the encapsulation is waterproof.

14. The illuminated article of claim 8, wherein the inverter circuitry comprises a power inverter capable of driving an electroluminescent panel of a cellular phone and having its load balancing characteristics adapted to drive electroluminescent wire.

15. The illuminated article of claim 8, wherein the article comprises apparel worn of the body of a wearer, and wherein the at least one first electroluminescent wire positions against the wearer's body and forms a structural component for supporting the appeal on the wearer.

16. The illuminated article of claim 8, further comprising a second electroluminescent wire incorporated into the article and coupled to the alternating current output power of the inverter circuitry in parallel to the at least one first electroluminescent wire.

17. An illuminated article worn on a wearer's body, comprising:
a module incorporated into the article such that the module forms a structural component for supporting the article on the wearer, the module having circuitry and a power source, the power source providing power to the circuitry and the circuitry producing output power; and
at least one electroluminescent wire coupled to the output power of the circuitry, the at least one wire incorporated into the article such that the at least one first electroluminescent wire forms a structural component for supporting the article on the wearer.

18. The illuminated article of claim 17, wherein the circuitry comprises a power inverter for converting direct current from the power source to alternating current for the output power.

19. The illuminated article of claim 18, wherein the power inverter is capable of driving an electroluminescent panel of a cellular phone and has its load balancing characteristics adapted to drive electroluminescent wire.

20. The illuminated article of claim 17, wherein the power source comprises at least one rechargeable battery.

21. The illuminated article of claim 17, wherein the module comprises a compact housing for enclosing the circuitry and the power source.

22. The illuminated article of claim 17, wherein the compact housing for the circuitry and the power source comprises an encapsulation.

23. The illuminated article of claim 17, wherein the module further comprises an electroluminescent panel coupled to the output power of the circuitry and at least partially exposed on the module.

24. The illuminated article of claim 17, wherein the illuminated article is selected from the group consisting of apparel, a bikini bottom, a thong, a bikini top, a bra, a bikini suit, a collar, a belt, shorts, a shoe, a sandal, athletic gear, a uniform, lingerie, swimming trunks, pants, a shirt, a safety vest, a raincoat, and jogging gear.

25. The illuminated article of claim 17, further comprising at least one clothing portion attaching to the at least one electroluminescent wire and positioning adjacent a portion of the wearer's body.

26. The illuminated article of claim 25, further comprising a releasable connector attaching the at least one electroluminescent wire to the clothing portion.

27. The illuminated article of claim 25, wherein the at least one electroluminescent wire includes first and second electroluminescent wires for positioning over the hips of the wearer's body and attaching to the clothing portion.

28. The illuminated article of claim 27, wherein the at least one electroluminescent wire includes further includes a third electroluminescent wire for positioning between the muscles of the wearer's buttocks and attaching to the clothing portion.

29. The illuminated article of claim 25, wherein:
the at least one clothing portion includes at least two clothing portions positioning adjacent the breasts of the body, and
the at least one electroluminescent wire includes:
a first electroluminescent wire for positioning on the torso of the wearer and attaching to one of the clothing portions, and
a second electroluminescent wire for positioning on the torso of the wearer and attaching to the other clothing portion.
